(19) United States
(12) Patent Application Publication
(10) Pub. No.: US 2011/0290662 A1
(43) Pub. Date: Dec. 1, 2011

(54) Method and Device for Electrochemical Machining

(75) Inventors: Patrick Matt, Marktoberdorf (DE); Michael Riester, Kellmunz (DE); David Saitner, Hawangen (DE)

(73) Assignee: EXTRUDE HONE GMBH, Remscheid (DE)

(21) Appl. No.: 12/672,394

(22) PCT Filed: Aug. 4, 2008
(86) PCT No.: PCT/EP08/60234

§ 371 Date: Jul. 7, 2011

(30) Foreign Application Priority Data
Sep. 14, 2007 (DE) 10 2007 044 091.1

(51) Int. Cl. B23H 3/10; B23H 3/00

(52) U.S. Cl. 205/641; 204/242; 204/232; 205/645

(57) ABSTRACT

The present invention relates to a device and a method for the electrochemical machining of at least one workpiece with a conductor and first storing element for an electrolyte, wherein at least one measuring unit for measuring at least one property of the electrolyte is arranged on the conductor.

The present invention relates to a device for electrochemical machining and to an electrochemical machining method. The electrochemical machining of workpieces makes it possible to carry out an especially accurate machining of electrically conductive and metallic workpieces. Machining takes place virtually free of wear and with great care being taken of the material. The invention is used particularly in the industrial sector and where large quantities are involved.

Electrochemical machining operates on the principle of electroerosion. For this purpose, for example, the workpiece is contacted anodically and the tool catholically. A conductive liquid, which is also designated as an electrolyte, is pumped through a working gap remaining between the workpiece and the tool. When an electrical voltage is applied between the workpiece and tool, a current flows and initiates electrolysis, by means of which metal ions are released from the workpiece. A defined erosion of the material is in this case achieved. With the aid of electrochemical machining, radii and contours can be manufactured with high accuracy even at locations where access is difficult. Furthermore, it is possible to machine various workpiece positions simultaneously. Since no direct contact occurs between the tool and the workpiece, machining takes place virtually free of wear, and a highly constant process quality is ensured. Moreover, no mechanical stresses or thermal influences are induced in the workpiece to be machined. Even materials which are difficult to cut can easily be machined by means of this machining method. On account of short cycle times, which may amount to a few seconds, it is possible to machine relatively large quantities with a high degree of process reliability. This method is in especially widespread use in the re-machining of ducts in injection nozzles.

In addition to the numerous advantages, mentioned above, which electrochemical machining possesses, it has been shown repeatedly, in practice, that the electrolyte used changes its properties during machining and influences the machining results.

The object of the present invention, therefore, is to solve at least partially the problems arising from the prior art and, in particular, to specify a device and a method, with the aid of which the electrolyte used can be conditioned in an improved way.

These objects are achieved by means of a device according to the features of patent claim 1 and by means of a method according to the features of patent claim 11. Further advantageous refinements of the invention are specified in the dependently formulated patent claims. It should be pointed out that the features listed individually in the dependently formulated patent claims may be combined with one another in any desired technologically expedient way and define further refinements of the invention. Furthermore, the features specified in the patent claims are detailed and explained more particularly in the description, further preferred exemplary embodiments of the invention being illustrated.

In the present case, the objects are achieved by means of a device for electrochemical machining of at least one workpiece, with conduction means and first storage means for an electrolyte, at least one measuring arrangement for measuring at least one property of the electrolyte being arranged on the conduction means. The measuring arrangement may in this case be mounted, for example, on a pipeline which is intended for conducting the electrolyte. Such or other known conduction means may lead, for example, to cooling assemblies or heat exchanger arrangements which serve for treating the electrolyte. Depending on the application, the measuring arrangement may be integrated on or else in the conduction means. Whereas incorrect measurements may occur when measuring arrangements are arranged in storage means, such as, for example, tanks or troughs, such incorrect measurements are avoided completely or are at least negligible by the measuring arrangement being arranged in a conduction means or on a conduction means. The reason for this is that, in large-volume storage means, the electrolyte which has accumulated there tends to the formation of layers. This means that the substances contained in the electrolyte may form themselves into various layers or phases having different properties. In the present case, layering occurs according to specific densities, but this is a disadvantage for electrochemical machining because a non-homogeneous electrolyte has just such properties. Above all, however, because of this, it is no longer reliably possible to detect the properties of the electrolyte uniformly in a way which should be as representative as possible of the overall electrolyte. The present invention recognized, then, that, in contrast to large-volume storage means, such adverse layerings do not occur in conduction means, or to only a very slight extent, with the result that highly accurate measurements become possible. Large-volume is in this case to be understood to mean, in particular, those storage means, of which the structural length in the through-flow direction of the electrolyte corresponds approximately to their structural height in the vertical direction and of which the cross section in the through-flow direction is larger than double the cross section of the conduction means used. Thus, even in the case of a storage means, the height of which corresponds to 0.5 times its length or more, undesirable layering may occur.

This is, above all, because a very good intermixing of the electrolyte takes place within the conduction means, and therefore the formation of layers is as far as possible ruled out. The measuring arrangements then arranged in the conduction means can thus deliver substantially more accurate and more reliable measurement values than has been possible hitherto.

Advantageously, within the scope of the present invention, there is provision for the measuring arrangement used to be designed at least for detecting the pH value, the conductivity or the temperature. The measuring arrangement may in this case be designed such that it can detect one or even more of the properties of the electrolyte. The term “conductivity” is understood to mean, in particular, the electrical conductivity of the electrolyte. In addition to the properties of the electrolyte which have been mentioned, however, further physical and chemical properties of the electrolyte may also be detected by means of a measuring arrangement within the scope of the present invention.

In a completely different preferred development of the invention, there is provision for a metering arrangement for introducing at least one metered substance into the electrolyte to be provided. While this preferred development is described within the scope of the present invention, it is also possible, furthermore, to implement and employ this development in an independent and advantageous way. Thus, by a metered substance being added, for example, the pH value of the electrolyte can be changed continuously or can be held at a predetermined value. The metering arrangement may in this case selectively act continuously or discontinuously. Particularly discontinuously acting metering arrangements, which are also designated as inoculation stations, may be employed and cause a specific pH value to be maintained in the electrolyte or an abrupt change in the pH value. Metered substances which may be considered, above all, are lyes or acids which are suitable for regulating or varying the pH value of the electrolyte. However, other metered substances may also be added thereto, which have advantageous effects for the electrochemical machining method.

In a further particularly advantageous embodiment of the invention, there is provision for at least one mixing device for the electrolyte to be arranged in the region of the conduction means or of the storage means. This development of the invention, described and claimed within the scope of the present invention, may also be implemented alone and employed advantageously, in order to achieve the advantageous effect described below. Thus, the mixing device may be designed, for example, in the form of a passive mixer which at least partially deflects the electrolyte flowing through the mixer, such that it is intimately intermixed. This may take place, for example, by means of guide plates, at which part streams of the electrolyte are deflected in the direction of other part streams of the electrolyte. Furthermore, however, active mixing devices which are driven, for example, by motors may also be used, which are arranged selectively in the conduction means or in the storage means. For example, these may comprise agitating mechanisms or other known mixing devices, many of which are known.

A completely different and likewise advantageous development of the invention, which can also be implemented independently as an invention, provides for a second storage means to be provided, which is arranged at least partially within the first storage means. A second storage means may be designed, for example, for receiving a metered substance, such as, for example, an acid or base, which is added to the electrolyte by means of a metering arrangement. If the second storage means for receiving this metered substance is arranged completely or partially within the first storage means, the first storage means being designed, for example, for receiving the electrolyte, then this considerably increases the safety of the device. If, for example, acid or lye used as a metered substance emerges from the second storage means on account of a defect, it does not pass directly into the surroundings, but, instead, is mixed with the electrolyte located in the first storage means.

Advantageously, there is in this case provision for the second storage means to be designed for receiving at least one metered substance. As already described above, this metered substance may be an acid or lye. Moreover, there may also be provision, however, for the second storage means to be designed for the simultaneous and separate reception of two or more metered substances, in order thereby to introduce the metered substances into a branch or a plurality of branches of the electrolyte.

It is most particularly advantageous for this purpose also if the device is designed such that at least one metering arrangement and at least one measuring arrangement are connected to a control arrangement. The connection between the said arrangements is to be understood, in particular, as meaning a control arrangement. This comprises, for example, means for signal transmission, but also means for energy transmission. In general, within the scope of the invention, control connections are to be understood as meaning all means whereby the metering arrangement or the measuring arrangement can be tied up to the control arrangement, so that these can perform the desired function. This involves processing the measurement values detected by means of the measuring arrangement in the control arrangement according to stipulated laws and subsequently transferring control commands in this case generated to the metering arrangement so that the latter can condition the electrolyte in the intended way. Moreover, conditioning is understood to mean the variation of specific properties of the electrolyte. These properties may be, for example, the pH value, temperature, conductivity, density or flow velocity, to name only a few by way of example.

Furthermore, within the scope of the present invention, there is advantageously provision for at least the conduction means, first storage means, conveying means and at least one machining space to form an electrolyte circuit. In such an electrolyte circuit, the electrolyte used can circulate and therefore be used more than once. This, on the one hand, saves an electrolyte and also reduces the outlay in terms of the conditioning of the electrolyte. In developments of the invention, there may also be provision for second storage means also to be used in the electrolyte circuit in addition to the first storage means. Furthermore, a plurality of machining spaces may also be fed from one common electrolyte circuit, with the result that the components provided for conditioning the electrolyte can be stocked once only. The outlay per machining space in terms of the devices required for conditioning is therefore significantly reduced.

It is also most particularly advantageous if at least the metering arrangement, the mixing device or the measuring arrangement is arranged downstream of the machining space. Especially good intermixing occurs there in the conduction means which conducts the electrolyte downstream of the machining space. Particularly when the metering arrangement is arranged directly upstream of a mixing device, the mixing device can mix the previously added metered substance in the electrolyte. Furthermore, it is especially good if a measuring arrangement used is seated directly downstream of the mixing device, since optimal intermixing of the electrolyte takes place here. In another embodiment, however, there may also be provision for the measuring arrangement to be arranged upstream of the metering arrangement in order thereby to determine the metering demand.

Furthermore, it is also advantageous if at least the first or the second storage means is arranged below the machining space. This aspect of the present invention, too, can be implemented alone in an independent and advantageous way. Arrangement below the machining space reduces the length of the conduction means required for electrolyte conduction, with the result that the risk of leakages and other faults is at the same time reduced. Moreover, below the machining space, a suitable construction space is present and easy access to the storage means is ensured, so that, for example, maintenance work can be carried out on these.

Further, the set object according to the invention is also achieved by means of an electrochemical machining method for operating a device of the type described here according to the invention, at least one property of an electrolyte being monitored by means of at least one measuring arrangement. The monitoring of the properties of the electrolyte, in particular in a conduction means, gives an operator or a control arrangement continuously highly accurate information on its properties and therefore on its state. This information can be evaluated and taken into account manually or automatically in the conditioning of the electrolyte. Consequently, “monitoring” means a continuous controlling of the property during machining, in particular during the entire machining process (period of time of voltage application). It is also possible, however, that “monitoring” takes place discontinuously, for example at concretely stipulated intervals and/or machining intermissions (voltage interruption).

There is in this case preferably provision for at least one metered substance to be added to the electrolyte by means of a metering arrangement. By means of the metering arrangement, the metered substance can be metered especially accurately, which would be achievable at most at considerable outlay in the case of manual addition. Furthermore, the metering arrangement may also be designed to introduce a plurality of metered substances into the electrolyte, as required, or to admix them to this.

In a preferred development, therefore, there is also provision for a metering of the metered substance to be set according to type or quantity as a function of the measured properties of the electrolyte. This method step may preferably be carried out by means of an automatically operating control arrangement which can execute metering in an automated, operator-friendly and especially exact way.

Furthermore, within the scope of the invention or independently, there may advantageously be provision for at least one lifting arrangement to be provided on the device. This lifting arrangement may serve, for example, for lifting conveying means or storage means out of the device. These have to be exchanged relatively frequently, for example, for maintenance purposes. This is the case particularly when pumps are used as conveying means. These are heavy and are therefore highly complicated to demount manually. A lifting device makes things particularly easy for the operator here.

The invention and the technical background are explained in more detail below with reference to the figures. It should be pointed out in this case that the figures show especially preferred design variants of the invention, but the latter is not restricted to these. In the diagrammatic drawing:

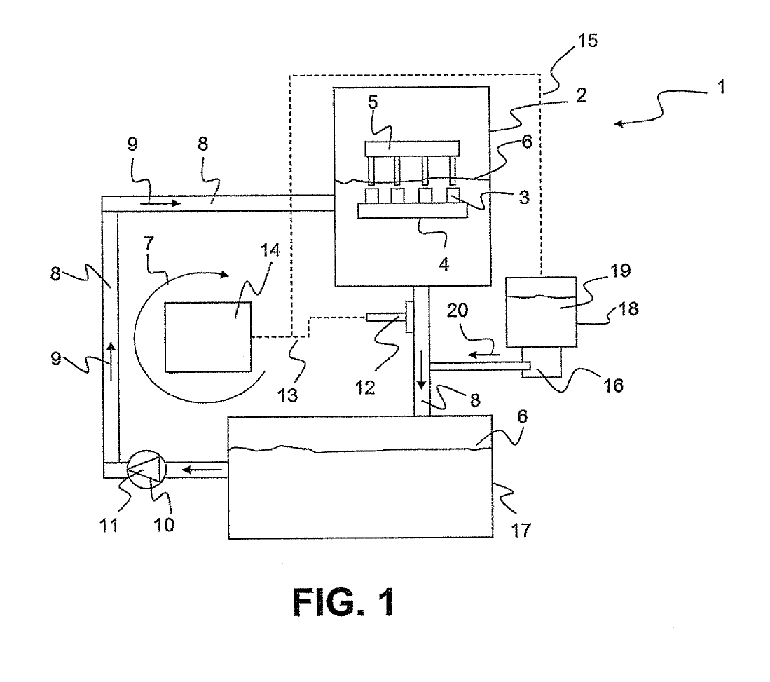

FIG. 1 shows a device for electrochemical machining; and

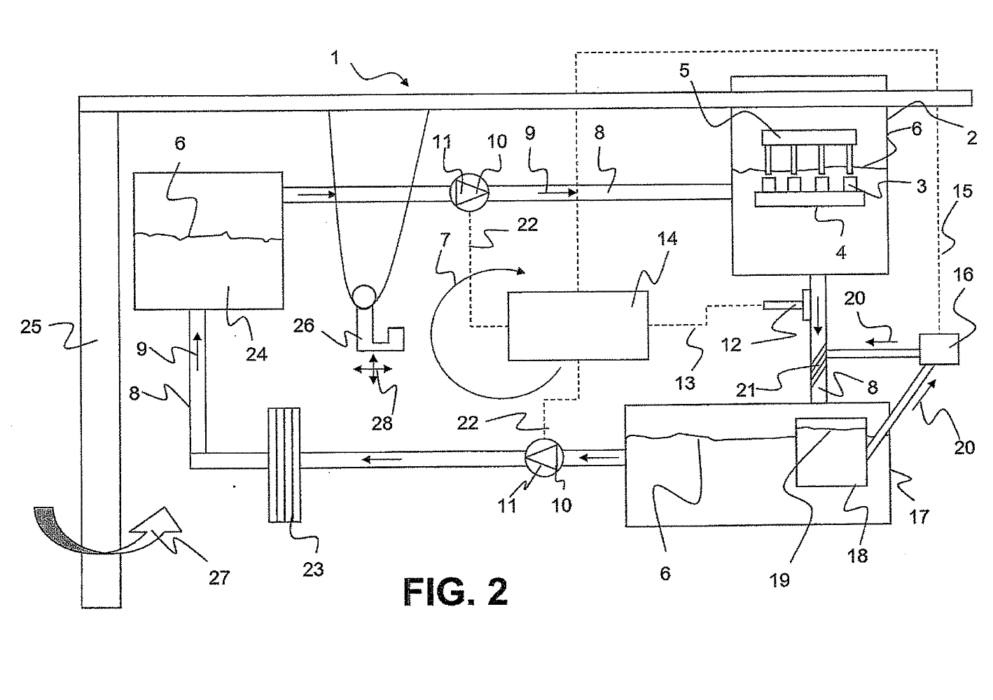

FIG. 2 shows a further embodiment of a device according to the invention for electrochemical machining.

FIG. 1 illustrates a device 1 for electrochemical machining in a diagrammatic view. Illustrated at top right is a machining space 2 in which components 3 provided for electrochemical machining are arranged between an anode 4 and a cathode 5. A liquid electrolyte 6 in this case washes around the components 3. The electrolyte 6 circulates in a circuit 7 through the conduction means 8 in the direction of the first arrows 9. This movement is driven by a conveying means 10 which is designed as a pump 11.

After flowing around the components 3, the electrolyte 6 flows downward out of the machining space 2. At least one property of the electrolyte 6 is measured there by means of a measuring arrangement 12. In the present case, this property is the pH value. The measuring arrangement 12 generates a signal representing the pH value of the electrolyte 6 and conducts this via a first signal line 13 to a control arrangement 14. The control arrangement 14, in turn, thereupon generates a further signal for controlling a metering arrangement 16 and conducts this signal via the second signal line 15 to the metering arrangement 16. The metering arrangement 16, in turn, is arranged above a first storage means 17 which serves as a store for electrolyte 6 and which is designed, for example, as a tank. The metering arrangement 16, in turn, has a second storage means 18 in which a metered substance 19 is located. The metered substance 19, which may, for example, be an acid or lye, is admixed to the circuit 7 and consequently to the electrolyte 6 in the direction of the second arrow 20 correspondingly to the signal received via the second signal line.

As soon as a change in the stipulated pH value, which is filed in the control arrangement 14, occurs, therefore, this being detected by the control arrangement 14 by means of the signal from the measuring arrangement 12, a corresponding conditioning of the electrolyte 6 is induced by the addition of a metered substance 19. The electrolyte 6 can therefore be used for a very long operating time and always has the monitored and conditioned properties.

FIG. 2 illustrates another preferred embodiment of a device 1 for electrochemical machining. Here, too, the machining space 2, in which the components 3 to be machined are located between the anode 4 and the cathode 5, is again arranged in the top right region. The electrolyte 6 again circulates in the direction of the first arrows 9 in a circuit 7. In this case, however, the second storage means 18 having the metered substance 19 is arranged within the first storage means 17 for the electrolyte 6. The advantage of this is that acid or lye emerging, for example, due to a leakage does not pass out of the second storage means 18 into the environment or surroundings. Instead, the emerging metered substance 19 is diluted by the electrolyte 6 located in the first storage means, thus reducing the risk of personal or material damage. Moreover, the second storage means 18 designed, for example, as an acid container is protected from damage by the first storage means 17. The metered substance 19 is again admixed to the circuit 7 from the second storage means 18 in the direction of the second arrows 20 by the metering arrangement 16. Admixture takes place after activation by the control arrangement 14 via the second signal line 15. In this preferred development of the invention, moreover, a mixing device 21 is provided which is arranged downstream of the machining space 2. The metered substance 19 is in this case introduced directly upstream or directly into the mixing device 21 in order thereby to be mixed directly with the electrolyte 6 flowing through. The mixing device illustrated is passive and deflects one or more part streams of the electrolyte 6 such that these impinge at an angle upon other part streams of the electrolyte 6 and are at the same time intermixed. In the embodiment shown, the control arrangement 14 has control lines 22, via which it can additionally control the power of the conveying means 11. It is consequently possible to vary the circulation velocity and flow velocities of the electrolyte 6 in the circuit 7, for example, as a function of a temperature of the electrolyte 6. Further, the intermixed electrolyte 6 is intermediately stored in the first storage means 17, in order thereafter to be transported by the conveying means 11 through a filter arrangement 23 to a third storage means 24. There, the purified and conditioned electrolyte 6 is provided for a renewed run through the machining space 2.

In addition, a lifting arrangement 25 is also provided, having a hook 26 which is freely movable in space as a result of rotation about the axis 27 and as a result of movement in the direction of the crossed arrows 28. This lifting arrangement 25 can be used by an operator of the device 1 in order, for example, to lift the relatively heavy pumps 11 out of the device 1 for maintenance purposes. This also applies to lifting out the storage means 17, 18 and 24, if this becomes necessary. Arranging a lifting arrangement 25 improves operating safety and makes it easier to operate the device 1.

Moreover, it is pointed out that the present invention is not restricted to the exemplary embodiments illustrated. On the contrary, numerous modifications of the device shown are possible within the scope of the patent claims. Thus, for example, instead of the storage means and metering arrangements described, those may also be used which have different operating principles, but cause the same effect. Furthermore, the number of metering arrangements, storage means, conduction means, filter arrangements and lifting arrangements and also measuring arrangements and control arrangements may be varied in order to implement specific functionalities additionally, without departing from the scope of protection of the present invention.

### LIST OF REFERENCE SYMBOLS

1 Device
2 Machining space
3 Component
4 Anode
5 Cathode
6 Electrolyte
7 Circuit
8 Conduction means
9 First arrow
10 Conveying means
11 Pump
12 Measuring arrangement
13 First signal line
14 Control arrangement
15 Second signal line
16 Metering arrangement
17 First storage means
18 Second storage means
19 Metered substance
20 Second arrow
21 Mixing device
22 Control line
23 Filter arrangement
24 Third storage means
25 Lifting arrangement
26 Hook
27 Axis of rotation

1-13. (canceled)

14. A device for electrochemical machining of at least one workpiece, with conduction means and first storage means for an electrolyte, at least one measuring arrangement for measuring at least one property of the electrolyte being arranged on the conduction means.

15. The device as claimed in claim 14, the measuring arrangement being designed at least for detecting the pH value, the conductivity or the temperature.

16. The device as claimed in claim 14, a metering arrangement for introducing at least one metered substance into the electrolyte being provided.

17. The device as claimed in claim 14, at least one mixing device for the electrolyte being arranged in the region of the conduction means or of the storage means.

18. The device as claimed in claim 14, a second storage means being provided, which is arranged at least partially within the first storage means.

19. The device as claimed in claim 14, the second storage means being designed for receiving at least one metered substance.

20. The device as claimed in claim 14, at least one metering arrangement and at least one measuring arrangement being connected to a control arrangement.

21. The device as claimed in claim 14, at least the conduction means, first storage means, conveying means and at least one machining space forming an electrolyte circuit.

22. The device as claimed in claim 14, at least the metering arrangement, the mixing device or the measuring device being arranged downstream of the machining space.

23. The device as claimed in claim 14, at least the first or second storage means being arranged below the machining space.

24. An electrochemical machining method for operating a device for machining at least one workpiece, wherein the device has conduction means and first storage means for an electrolyte, at least one measuring arrangement for measuring at least one property of the electrolyte being arranged on the conduction means, with at least one property of an electrolyte being monitored by means of at least one measuring arrangement.

25. The method as claimed in claim 24, with at least one metered substance being added to an electrolyte by means of a metering arrangement.

26. The method as claimed in claim 25, with a metering of the metered substance being set according to type or quantity as a function of the measured properties of the electrolyte.
